(19) United States
(12) Patent Application Publication
(10) Pub. No.: US 2015/0146969 A1
(43) Pub. Date: May 28, 2015

(54) METHOD FOR DETECTING A STRUCTURE TO BE APPLIED TO A SUBSTRATE WITH A PLURALITY OF OPTICAL IMAGE ACQUISITION UNITS AND AN APPARATUS THEREFOR

(71) Applicant: QUISS QUALITATS-INSPEKTIONSSYSTEME UND SERVICE AG, Puchheim (DE)

(72) Inventor: Bernhard Gruber, Stockdorf (DE)

(21) Appl. No.: 14/402,743

(22) PCT Filed: May 15, 2013
(86) PCT No.: PCT/EP2013/060044

§ 371 Date: Nov. 21, 2014

(30) Foreign Application Priority Data
May 21, 2012 (DE) 10 2012 009 859.6

(51) Int. Cl. G06T 7/00; G06T 11/60

(52) U.S. Cl. CPC G06T 7/001; G06T 7/0044; G06T 11/60
USPC 382/151

(57) ABSTRACT

A method and an apparatus are disclosed for detecting a structure to be applied to a substrate, such as an adhesive bead or a sealant track, with one or more optical acquisition apparatuses. The images from the optical acquisition apparatuses are combined to form a plan view such that a representation of the optical acquisition devices is output in a common image. The optical acquisition devices have, as a center, an application device for applying the structure to the substrate.

The present invention relates to a method for detecting and assessing a structure to be applied to a substrate with at least one or a number of optical image acquisition units according to the preamble to claim 1 and to a corresponding apparatus for this purpose.

Up to now optical measurements have conventionally been taken in order to detect a structure to be applied to a substrate, different systems for the fully automatic examination of the structure, for example adhesive and sealing beads, often being used.

Publication US 2002/113198 A1 discloses an optical detection device for detecting bead-shaped dispensed materials. The detection system includes a housing having a number of optical sensors which are mounted on the housing, the optical sensors being formed in the form of a large number of optical fibres. Furthermore, a material applicator is mounted within a central opening of the housing and extends through the opening such that the sensors substantially surround the applicator, the material that is dispensed by the applicator being detected continuously by means of the sensors. The subject matter of US 2002/113198 A1 also includes a method for detecting the material that is dispensed onto a workpiece using a robotic apparatus having an articulated arm.

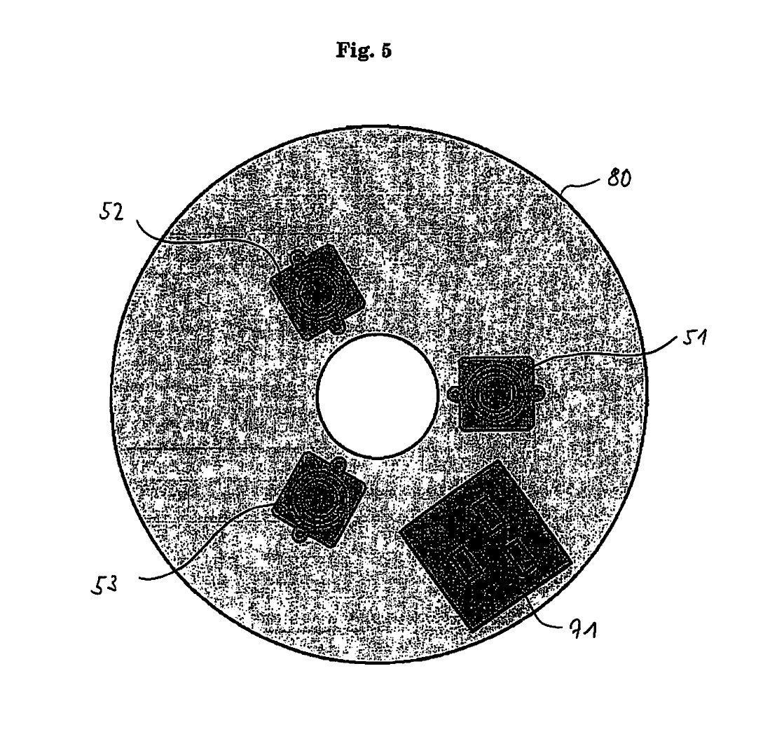

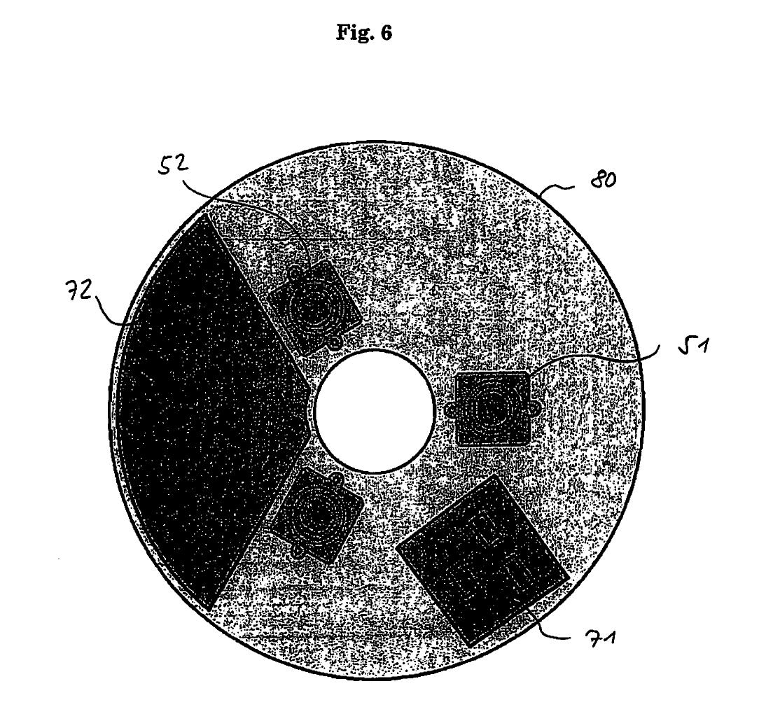

It is known that these types of apparatus have a number of cameras within the sensor head, as described for example by EP 1701803. For this purpose classically one to a number of cameras, preferably three cameras, are used which are arranged around the application device for continuous detection, even with a web-shaped extension of the structure. The images acquired are forwarded independently of one another to a higher-level computer for analysis. For this purpose it is necessary to transfer the image data in video format or in already digitalised form separately for each camera, as shown for example in FIGS. 5 and 6 of EP 1701803.

The web-shaped extension of the structure to be applied to the substrate is problematic here because the structure changes dependently upon the movement of the application device relative to the substrate from the monitoring region of a camera into the monitoring region of another camera. For the viewer of the respective images of a camera an easily comprehensible representation of the extension of the adhesive track is therefore not produced.

It is therefore an object of the present invention to provide a method or an apparatus for detecting a structure to be applied to a substrate for at least two or a number of optical acquisition devices which facilitates the monitoring and representation of the application structure or adhesive track.

Furthermore, it is an object of the present invention to provide a method or an apparatus for detecting a structure to be applied to a substrate for at least two or a number of cameras which reduces the transfer of the image information to a higher-level computer.

These objects are achieved by the method features of claim 1 and by the apparatus features of claim 11.

According to the invention at least one optical acquisition apparatus, in particular a number of, and preferably three, acquisition apparatuses are provided, the images of the optical acquisition apparatuses being combined to form a plan view such that the representation of the optical acquisition devices is output in a common image, the optical acquisition devices having, as a centre, an application device for applying the structure to the substrate. In this way viewing is facilitated for users who can detect the profile of the application structure without any problem by means of the plan view, this having led to ambiguities for the viewer in the known representation according to the unstructured strips of images as for example in FIGS. 5 and 6 of EP 1701803, in particular in the change-over from one camera to the next camera. According to the invention a view is provided for the observer which on the one hand makes possible the angle of viewing from the perspective of the application device, and on the other hand simplifies the documentation of the application structure.

Preferably, the images of the optical acquisition apparatuses, consisting of a number of image acquisition sensors, are assembled to form an overall image in order to produce a 360° view around the application unit. The overall image is already assembled in the sensor head, and this reduces the wiring. The realisation of a number of optical units within the sensor system makes a very compact sensor possible. At least two, preferably three optical acquisition devices (CCD or CMOS chips) are already assembled within the sensor head to form a preferably round overall image.

It is particularly advantageous if the image acquisition frequency is increased according to the reduction of data by only acquiring a defined section of the image of each optical acquisition apparatus, the section preferably being a disc segment. The read-out region is defined during calibration and so is electronically adjusted. By means of the defined section of the image for the further image analysis, mechanical calibration of the acquisition devices can also be dispensed with, by means of which set-up times and complex alignment elements can be cut down on because the calibration takes place electronically by the defined selection of the section of the image. Furthermore, by the defined delimitation of the image of the respective optical acquisition apparatus to be analysed, the image acquisition frequency can be increased.

If the optical acquisition apparatuses are arranged around the application device within a sensor head, the optical acquisition apparatuses respectively having a CCD chip or CMOS chip which are respectively connected to a device for assembling the overall image within the sensor head, the component requirement is then reduced, by means of which a compact structure of the apparatus according to the invention is also made possible.

As a consequence of the compact structure, geometrically complex components can in turn be examined because the sensor head has smaller outside dimensions. If three image sensors, in particular CCD or CMOS image sensors, are already assembled within the sensor head to form an image and are transferred to the external image analysis unit as an overall image, this reduces the component requirement and makes a more compact structure of the sensor system possible. Moreover, just one overall image per acquisition is transferred, and so the wiring is reduced. A further essential advantage is that the image sensors acquire the images synchronously, and due to this temporal assignment of the individual image sensors is not required.

According to a preferred embodiment, the optical acquisition apparatuses are connected within the sensor head to a device for trigger and flash control for the illumination which is made in particular in the form of a plurality of flashed LEDs within the sensor head. In order to generate sharp images when the application apparatus is at high speed, the image sensors are triggered synchronously with the illumination with a short exposure time. Up until now, a separate trigger line from an external image analysis unit has been required for the triggering of the image sensors. The trigger for the image sensors is produced by means of optical coupling of the illumination within the sensor, and so in this way the trigger line is dispensed with.

A further advantage of the invention is that the optical acquisition apparatuses, the device for trigger and flash control and the device for assembling the overall image are connected within the sensor head such that just one connection of the sensor head to an external processing device, in particular an Ethernet connection, is provided for detecting and examining the structure to be applied so that the control for the flash controller is integrated into the sensor. This reduces the wiring because only Gigabit Ethernet connection plus Power over Ethernet is sufficient for the apparatus according to the invention. The main advantage of Power over Ethernet is that one can save on a power supply cable, and so one can also install Ethernet-connected devices at poorly accessible locations or in areas in which a large number of cables would be troublesome. Thus, on the one hand one can partially make drastic savings on installation costs, and on the other hand the use of a central, interruption-free power supply, which is therefore easy to produce, can increase the fail-safe operation of the connected devices.

According to the profile of the application structure, for monitoring there is an automatic switch from a disc segment of an optical acquisition device to another disc segment of the adjacent optical acquisition device if the application structure to be monitored runs from a disc segment of an optical acquisition device to another disc segment of the adjacent optical acquisition device.

Additional advantageous configurations of the invention are the subject matter of the other sub-claims.

Advantageous configurations of the invention are shown by means of the following drawings as examples.

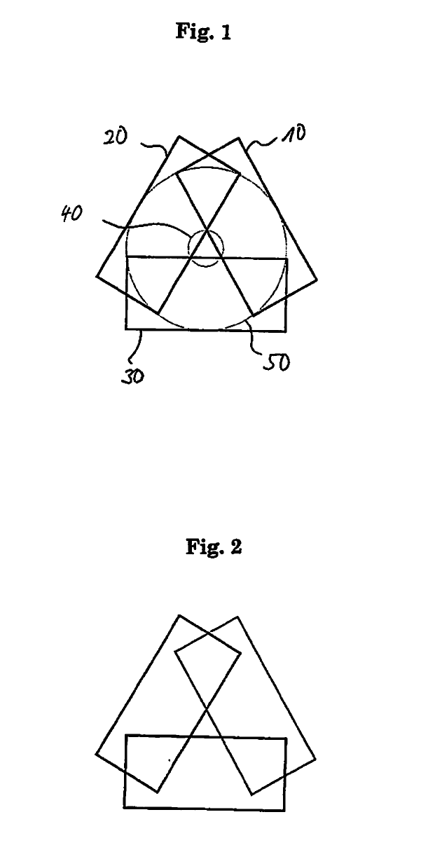

FIG. 1 shows a diagrammatic representation of a method according to the invention for monitoring an adhesive track.

FIG. 2 shows a diagrammatic representation of the method according to the invention of FIG. 1.

FIG. 3 shows a diagrammatic representation of the image according to the method according to the invention of FIGS. 1 and 2 without the adhesive track.

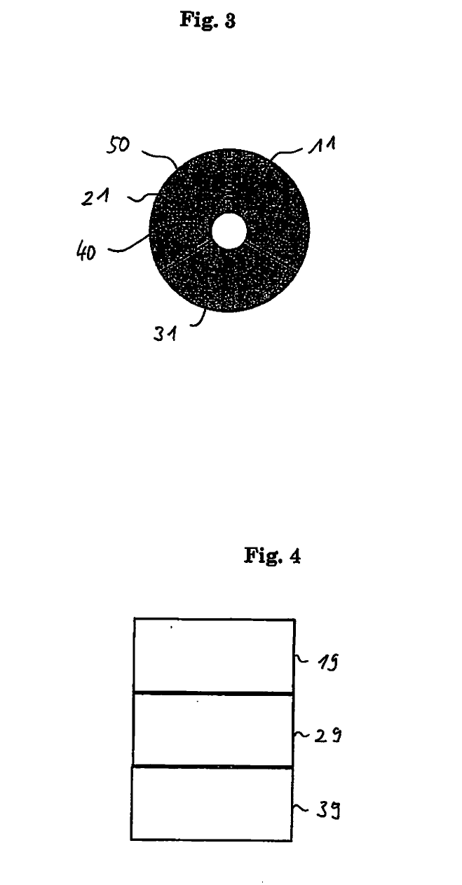

FIG. 4 shows an image of cameras according to the prior art for monitoring adhesive.

FIG. 5 is a representation of an apparatus according to the invention.

FIG. 6 shows a representation of an apparatus according to the invention with trigger and flash control.

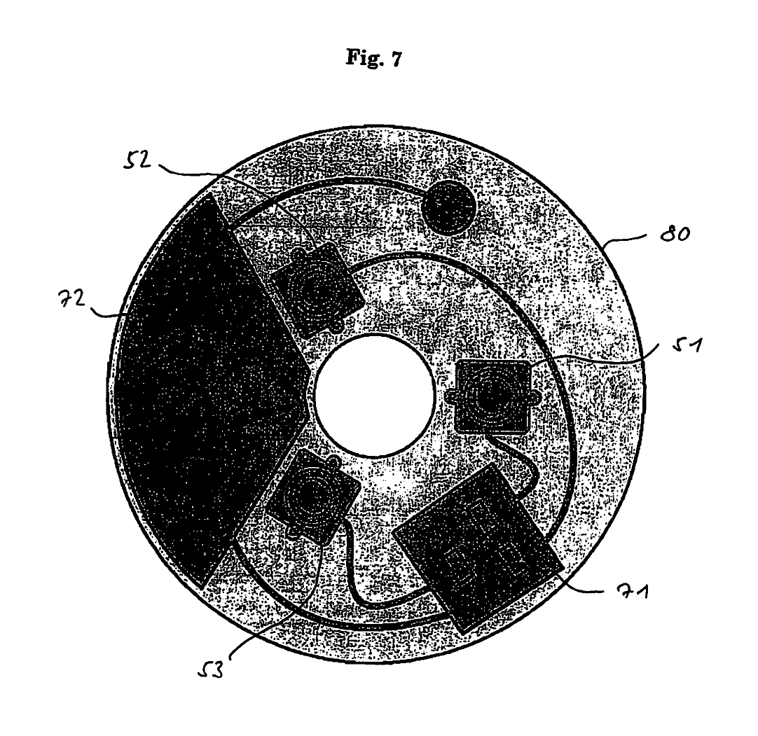

FIG. 7 shows a representation of an apparatus according to the invention with connection lines.

In the following only the method according to the invention for detecting a structure to be applied to a substrate according to FIGS. 1 to 3 will be described.

According to FIG. 1 the essential features for applying and detecting an adhesive track according to the invention are shown. Three rectangles 10, 20 and 30, offset in relation to one another, respectively show a strip of images from three optical acquisition apparatuses which are arranged around an application device, which is indicated diagrammatically by the circle 40, preferably within a sensor head. The monitoring of the adhesive track (not shown) takes place between the circle 40 of the application device and the outer monitoring circle 50.

In FIG. 2 the rectangles 10, 20 and 30 are shown separately, each one showing a strip of images from three optical acquisition apparatuses which are used to analyse the image.

FIG. 3 shows an overall image of the active region of the adhesive examination, the images of the optical acquisition apparatuses being combined in disc segments 11, 21, 31 to form a plan view such that the representation of the optical acquisition devices is output in a common image, the optical acquisition devices having, as a centre, an application device for applying the structure to the substrate. The disc segments 11, 21, 31 respectively result from the image strips 10, 20, 30, the boundary region running from the centre outwards, and being limited by the outer ring 50 and the inner circle 40. Therefore, the adhesive track to be monitored runs constantly outwards from the inner circle 40 and is examined in at least one disc segment 11, 21, 31 and shown here such that viewing is simplified for users who can detect the profile of the application structure by means of the plan view produced without any problem, this having led to ambiguities for the viewer in the known representation according to the unstructured image strips as, for example, in FIGS. 5 and 6 of EP 1701803 and in FIG. 4, in particular in the changeover from one camera to the next camera.

In FIG. 4 the image strips 19, 29, 39 are shown one beneath the other, this corresponding to image strips 10, 20, 30 with the respective overlap regions according to FIG. 1.

A view which, on the one hand, makes possible the viewing angle from the perspective of the application device and on the other hand the documentation of the application structure is produced for the viewer with respect to the representation of FIG. 4 by means of the representation according to the invention of FIG. 3.

Preferably, the images of the optical acquisition apparatuses consisting of a number of image acquisition sensors are assembled to form an overall image consisting of disc segments 11, 21, 31 in order to produce a 360° view around the application unit.

In the following the apparatus according to the invention for detecting a structure to be applied to a substrate will now be described according to FIGS. 5 to 7.

According to FIG. 5 there is shown, as an example, a sensor head 80 of the apparatus according to the invention in which 3 CCD chips 51, 52, 53 are arranged concentrically around an opening for an application device (not shown). Furthermore, there is provided within the sensor head 80 a device for assembling the overall image 71 to which the 3 CCD chips 51, 52, 53 are connected in order to already generate in the sensor head an overall image which is passed on to an external analysis unit, this reducing wiring.

In FIG. 6 the structure of FIG. 5 is extended by a diagrammatically illustrated device for trigger and flash control 72 for an illumination module which can be made in particular in the form of a plurality of flashed LEDs within the sensor head. In order to generate sharp images when the application apparatus is at high speed, the image sensors are triggered synchronously with the illumination with a short exposure time. Up until now a separate trigger line from an external image analysis unit has been required for the triggering of the image sensors. By optical coupling of the illumination in the sensor the trigger for the image sensors is generated, and so in this way the trigger line is dispensed with.

FIG. 7 shows the structure of the apparatus according to the invention of FIG. 6, the electrical connections between the CCD chips 51, 52, 53 and the device for assembling the overall image 71 respectively being shown, which in turn is connected to the device for the trigger and flash control 72 for an illumination module. It is therefore an additional advantage of the invention that the optical acquisition apparatuses 51, 52, 53, the device for the trigger and flash control 72, and the device for assembling the overall image 71 are connected within the sensor head in such a way that a single connection of the sensor head to an external processing device, in particular an Ethernet connection, is provided for detecting and examining the structure to be applied so that the control for the flash controller is integrated into the sensor. This reduces the wiring because only Gigabit Ethernet connection plus Power over Ethernet is sufficient for the apparatus according to the invention. The main advantage of Power over Ethernet is that one can cut down on a power supply cable and so Ethernet-connected devices can also be installed at poorly accessible locations or in areas in which a large number of cables would be troublesome. One can thus on the one hand partially drastically cut down on installation costs, and on the other hand the use of a central interruption-free power supply, which is therefore easy to realise, can increase the fail-safe operation of the connected devices.

Furthermore, according to the invention the teach-in run can generate the image sequence which then enables automatic parameterisation. This parameterisation can optionally be pre-set by the user and is used for the inspection run together with a progress file for the inspection of an applied adhesive track.

The invention thus describes a method and an apparatus having at least one optical acquisition apparatus, in particular a number of, preferably three, optical acquisition apparatuses, the images of the optical acquisition apparatuses being combined to form a plan view such that the representation of the optical acquisition devices is output in a common image, the optical acquisition devices having, as a centre, an application device for applying the structure to the substrate.

1-20. (canceled)

21. A method for detecting a structure to be applied to a substrate, such as an adhesive bead or a sealant track, with a number of optical acquisition apparatuses comprising a number of image acquisition sensors, the method comprising:
combining images of the optical acquisition apparatuses to form a plan view such that a representation of the optical acquisition devices is output in a common image such that in the common image of the optical acquisition devices, as a center, the position of an application device for applying the structure to the substrate is provided; and
arranging the optical acquisition apparatuses around the application device within a sensor head, the optical acquisition apparatuses being connected within the sensor head to a device for assembling the overall image;
wherein the images of the optical acquisition apparatuses are assembled to form a common image which is assembled from images in the form of disc segments of the optical acquisition apparatuses in order to produce a 360° view around the application unit.

22. The method of claim 21 wherein an image acquisition frequency is increased according to a reduction of data by only acquiring a defined section of the image of each optical acquisition apparatus.

23. The method of claim 22 wherein the optical acquisition apparatuses each have a CCD chip or CMOS chip.

24. The method of claim 21 wherein the optical acquisition apparatuses are connected within the sensor head to a device for trigger and flash control for illumination which is made in particular in a form of a plurality of flashed LEDs within the sensor head.

25. The method of claim 24 wherein the optical acquisition apparatuses, the device for trigger and flash control and the device for assembling the overall image are connected within the sensor head such that just one connection of the sensor head to an external processing device is provided for detecting and examining the structure to be applied.

26. The method of claim 23 wherein only approximately ¼ of image lines are used as strips of the image for each CCD chip or CMOS chip, and the image acquisition frequency is quadrupled.

27. The method of claim 21 wherein a paramaterization of an image sequence obtained from a reference application structure and which results from a single image acquisition run of all of the optical acquisition devices is automatically undertaken by a one-off external indication of the reference application structure and is used for comparison with an applied adhesive track.

28. The method of claim 21 wherein the images of the optical acquisition devices are used to examine the applied structure, the images of all of the optical acquisition devices together forming a disc around the application device.

29. The method of claim 21 wherein, according to a profile of the application structure, for monitoring there is an automatic switch from a disc segment of an optical acquisition device to another disc segment of an adjacent optical acquisition device if the application structure to be monitored runs from a disc segment of an optical acquisition device to another disc segment of the adjacent optical acquisition device.

30. An apparatus for detecting a structure to be applied to a substrate, such as an adhesive bead or a sealant track, the apparatus comprising:
a plurality of optical acquisition apparatuses comprising a number of image acquisition sensors, wherein images of the optical acquisition apparatuses are combined to form a plan view such that a representation of the optical acquisition devices is output in a common image; and
an application device arranged between the optical acquisition devices in order to apply the structure to the substrate;
wherein the optical acquisition apparatuses are arranged around the application device within a sensor head, the optical acquisition apparatuses respectively being connected within the sensor head to a device for assembling the overall image, and wherein the images of the optical acquisition apparatuses are assembled to form an overall image which is made up of images in the form of disc segments of the optical acquisition apparatus in order to produce a 360° view around the application unit.

31. The apparatus of claim 30 wherein an image acquisition frequency is increased according to a reduction of data due to the acquisition of just one defined section of the image of each optical acquisition apparatus

32. The apparatus of claim 30 wherein the optical acquisition apparatuses each have a CCD chip or CMOS chip.

33. The apparatus of claim 30 wherein the optical acquisition apparatuses are connected within the sensor head to a device for trigger and flash control for illumination which is made in particular in a form of a plurality of flashed LEDs in the sensor head.

34. The apparatus of claim 33 wherein the optical acquisition apparatuses, the device for trigger and flash control and the device for assembling the overall image are connected within the sensor head such that just one connection of the sensor head to an external processing device is provided for detecting and examining the structure to be applied.

35. The apparatus of claim 32 wherein only approximately ¼ of image lines are used as strips of the image for each CCD chip or CMOS chip, and the image acquisition frequency is quadrupled.

36. The apparatus of claim 30 wherein a parameterisation of an image sequence obtained from a reference application structure and which results from a single image acquisition run of all of the optical acquisition devices is automatically undertaken by a one-off external indication of the reference application structure and is used for comparison with an applied adhesive track.

37. The apparatus of claim 30 wherein the images of the optical acquisition devices are used to examine the applied structure, the images of all of the optical acquisition devices together forming a disc around the application device.

38. The apparatus of claim 30 wherein, according to a profile of the application structure, for monitoring there is an automatic switch from a disc segment of an optical acquisition device to another disc segment of an adjacent optical acquisition device if the application structure to be monitored runs from a disc segment of an optical acquisition device to another disc segment of the adjacent optical acquisition device.
